(19) United States
(12) Patent Application Publication
(10) Pub. No.: US 2016/0175868 A1
(43) Pub. Date: Jun. 23, 2016

(54) SPRAY HEAD ASSEMBLY

(71) Applicant: Shwu-Ruu Chern, Taichung (TW)

(72) Inventor: Shwu-Ruu Chern, Taichung (TW)

(21) Appl. No.: 14/578,272

(22) Filed: Dec. 19, 2014

(51) Int. Cl. B05B 11/00

(52) U.S. Cl. CPC B05B 11/3098; B05B 11/0018

(57) ABSTRACT

A spray head assembly includes a bottle having an opening defined in the top thereof, and a protrusion extends from an inner end of bottle. An installation hole is defined through the protrusion and an air valve is sealed in the installation hole. An end of the air valve communicates with outside of the bottle. A nozzle is engaged with the opening of the bottle and connected with a hose which is inserted into the bottle. A mount is mounted to the top of the bottle and the nozzle extends from a through hole of the mount. Air is introduced into the bottle via the air valve to atomize the liquid which can be sprayed from the nozzle.

### BACKGROUND OF THE INVENTION

1. Fields of the Invention

The present invention relates to a spray head assembly, and more particularly, to a spray head assembly with an air valve for introducing air into the bottle to atomize the liquid which is sprayed from the nozzle.

2. Descriptions of Related Art

The conventional spray head assembly connected to a bottle is designed to spray the liquid in the bottle, and the liquid can be detergent liquid or lotion. However, the conventional spray head assembly cannot control the amount of the liquid that is sprayed from the nozzle per squeeze, so that the liquid squeezed from the nozzle may be more than needed and this requires more water to flush it from the object or body.

Some of the conventional spray head assemblies are able to atomize the liquid, but they usually have a complicated mechanism and the level of atomization of the liquid is not satisfied.

The present invention intends to provide a spray head assembly to eliminate the shortcomings mentioned above.

### SUMMARY OF THE INVENTION

The present invention relates to a spray head assembly and comprises a bottle having an opening defined in the top thereof. A protrusion extends from the inner end of bottle and an installation hole is defined through the protrusion. An air valve is sealed in the installation hole and an end of the air valve communicates with outside of the bottle. A nozzle is connected with a hose. The nozzle is engaged with the opening of the bottle and the hose is inserted into the bottle. A mount is mounted to the top of the bottle and has a through hole. The nozzle extends from the through hole of the mount.

Preferably, the bottle has outer threads defined in the outside of the top of the bottle, and the mount has inner threads which are threadedly connected to the outer threads.

Preferably, the air valve is a one-way valve. Preferably, the nozzle has a flange extending outward therefrom. The flange is rested on the top of the bottle.

Preferably, the bottle has multiple scale marks formed on the outside thereof.

Preferably, the bottle has a passage defined through the wall thereof and the passage is located close to the opening. A pressure stabilization valve is engaged with the passage.

The primary object of the present invention is to provide a spray head assembly which is cooperated with an air valve located at the bottom of the bottle, the air valve introduces air into the bottle to atomize the liquid and the atomized liquid is sprayed from the nozzle of the spray head assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the spray head assembly of the present invention;

FIG. 2 is another exploded view of the spray head assembly of the present invention, wherein the bottle is shown in cross sectional view;

FIG. 3 is a perspective view to show the spray head assembly of the present invention installed to a bottle, and

FIG. 4 is another perspective view to show the spray head assembly of the present invention installed to a bottle.

### DETAILED DESCRIPTION OF THE PREFERRED EMBODIMENT

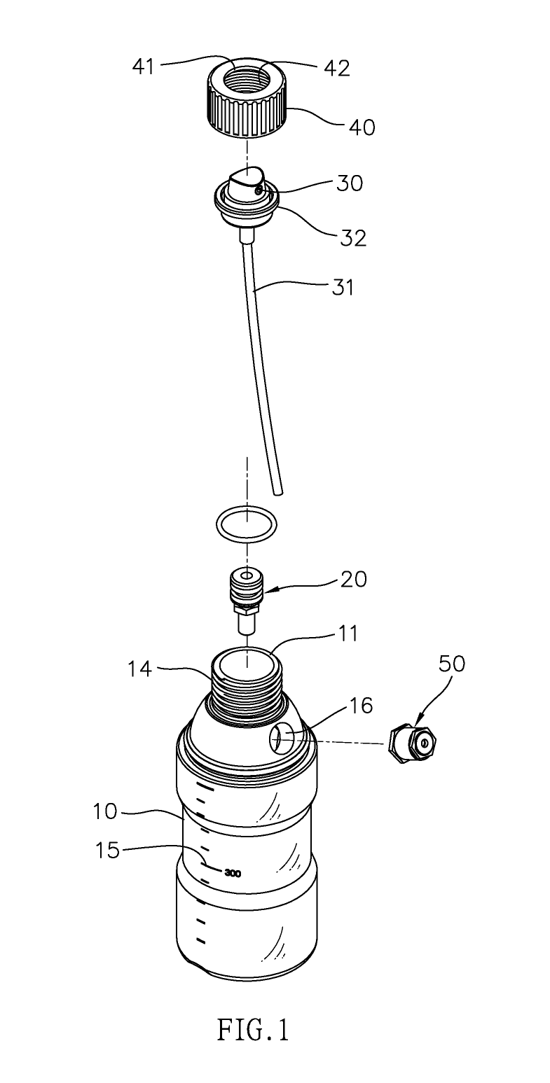

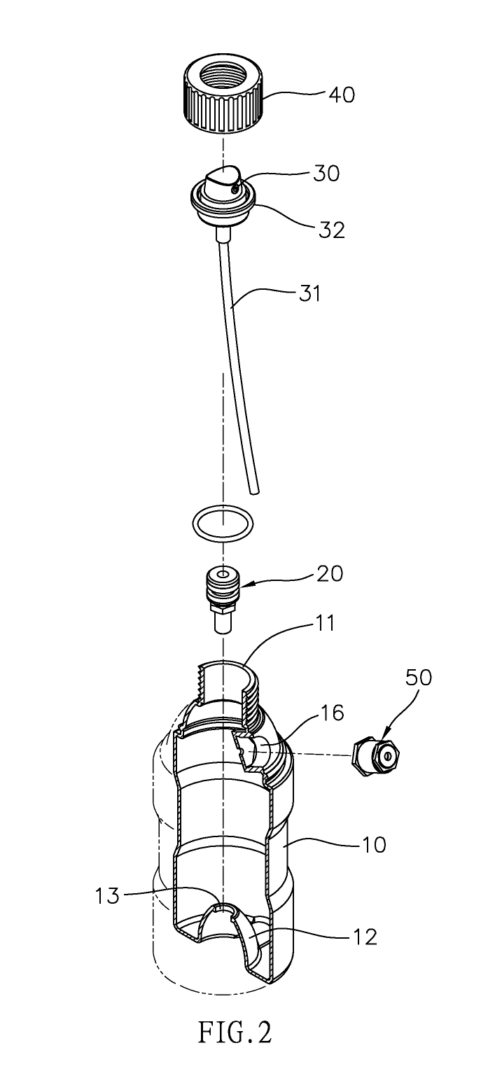

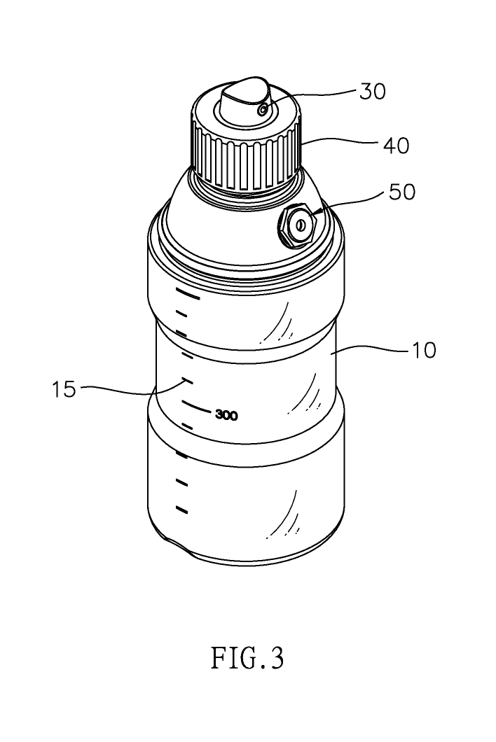

Referring to FIGS. 1 to 4, the spray head assembly of the present invention comprises a bottle 10 having an opening 11 defined in the top thereof and outer threads 14 are defined in the outside of the top of the bottle 10. A protrusion 12 extends from the inner end of bottle 10 and an installation hole 13 is defined through the protrusion 12.

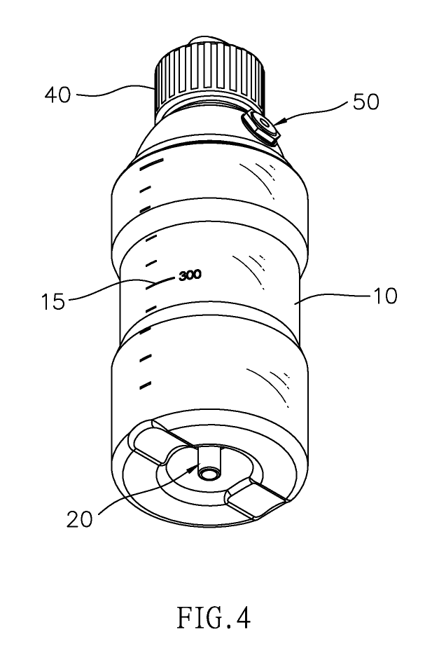

An air valve 20 is sealed in the installation hole 13 and an end of the air valve 20 communicates with outside of the bottle 10. The air valve 20 is a one-way valve. Preferably, there are two recessed grooves formed in the underside of the bottle 10 so that air can be sucked by the air valve 20 via the grooves as shown In FIG. 4.

A nozzle 30 is connected with a hose 31, and the nozzle 30 is engaged with the opening 11 of the bottle 10. The hose 31 is inserted into the bottle 10. A mount 40 is mounted to the top of the bottle 10 and has a through hole 41 defined centrally therethrough. The mount 40 has inner threads 42 which are threadedly connected to the outer threads 14. The nozzle 30 extends from the through hole 41 of the mount 40. The nozzle 30 has a flange 32 extending outward therefrom, the flange 32 is rested on the top of the bottle 10 and the mount 40 restricts and position the flange 32 on the top of the bottle 10. The bottle 10 has multiple scale marks 15 formed on the outside thereof so that the user is acknowledged the desired volume of the liquid/detergent/lotion is poured in the bottle 10. Furthermore, the bottle 10 has a passage 16 defined through the wall thereof and the passage 16 is located close to the opening 11. A pressure stabilization valve 50 is engaged with the passage 16.

When in use, the liquid/detergent/lotion is poured in the bottle 10 and left a space in the upper portion of the bottle 10 to air. The pressure stabilization valve 50 is located corresponding to the space filled with air. The air valve 20 is activated to suck air into the bottle to atomize liquid/detergent/lotion. The user then presses the nozzle 30 so as to spray the atomized liquid/detergent/lotion therefrom.

The pressure stabilization valve 50 is a safety valve to avoid the pressure in the bottle 10 from raising too high to break the bottle 10.

While we have shown and described the embodiment in accordance with the present invention, it should be clear to those skilled in the art that further embodiments may be made without departing from the scope of the present invention.

What is claimed is:

1. A spray head assembly comprising:
a bottle having an opening defined in a top thereof, a protrusion extending from an inner end of bottle, an installation hole defined through the protrusion;
an air valve being sealed in the installation hole, an end of the air valve communicating with outside of the bottle;
a nozzle connected with a hose, the nozzle being engaged with the opening of the bottle and the hose inserted into the bottle, and
a mount having a through hole defined centrally therethrough, the mount mounted to the top of the bottle and the nozzle extending from the through hole of the mount.

2. The spray head assembly as claimed in claim 1, wherein the bottle has outer threads defined in an outside of the top of the bottle, the mount has inner threads which are threadedly connected to the outer threads.

3. The spray head assembly as claimed in claim 1, wherein the air valve is a one-way valve.

4. The spray head assembly as claimed in claim 1, wherein the nozzle has a flange extending outward therefrom, the flange is rested on the top of the bottle.

5. The spray head assembly as claimed in claim 1, wherein the bottle has multiple scale marks formed on an outside thereof.

6. The spray head assembly as claimed in claim 1, wherein the bottle has a passage defined through a wall thereof and the passage is located close to the opening, a pressure stabilization valve is engaged with the passage.
